(19) United States
(12) Patent Application Publication
(10) Pub. No.: US 2022/0372362 A9
(43) Pub. Date: Nov. 24, 2022

(54) Dual Function Inhibitor Compounds For Deepwater Umbilical Applications

(71) Applicant: Halliburton Energy Services, Inc., Houston, TX (US)

(72) Inventors: Loan K. Vo, Houston, TX (US); Philippe Prince, Pearland, TX (US); Nathan Darrell Davis, Conroe, TX (US)

(73) Assignee: Halliburton Energy Services, Inc., Houston, TX (US)

(21) Appl. No.: 16/860,851

(22) Filed: Apr. 28, 2020

Related U.S. Application Data
(63) Continuation-in-part of application No. 16/642,278, filed on Feb. 26, 2020.

(51) Int. Cl. C09K 8/54; C09K 8/52

(52) U.S. Cl. CPC C09K 8/54; C09K 8/52; C09K 2208/22

(57) ABSTRACT

A method is disclosed that includes introducing one or more dual function inhibitor compounds through an umbilical into a deepwater environment such that the one or more dual function inhibitor compounds are introduced into a fluid in the deepwater environment. The dual function inhibitor is a corrosion inhibitor and a hydrate inhibitor.

### BACKGROUND

In deepwater applications, there are many challenges to address. Two of the most problematic challenges are corrosion and gas hydrates. Offshore deepwater production may require the addition of multiple chemicals to methods or systems in order to facilitate production, ensure continuous flow, and maintain production systems integrity. The development of stable compositions comprising multiple active compounds may be challenging. Space constraints and limited availability in deepwater environments, specifically in subsea injection lines or umbilical lines, present unique issues.

A common contributor to corrosion in these applications is acidic fluids. Acidic fluids are present in a multitude of operations in the oil and gas industry. In operations using acidic well fluids, metal surfaces of equipment such as piping, tubing, pumps, blending equipment, and umbilical lines may be exposed to the acidic fluid. The acidic fluids may include one or more of a variety of acids, such as hydrochloric acid, acetic acid, formic acid, hydrofluoric acid, or any combination of such acids. In addition, many fluids used in the oil and gas industry may include a water source that may incidentally contain certain amounts of acid, which, in turn, may cause the fluid to be at least slightly acidic. Even weakly acidic fluids may be problematic in that they may cause corrosion of metals. Corrosion may occur anywhere in a well production system or pipeline system.

Corrosion inhibitors have been used to combat potential corrosion problems in operations with acidic fluids, thereby reducing corrosion to metals and metal alloys with varying degrees of success. A difficulty encountered with the use of some conventional corrosion inhibitors is the limited temperature range over which they, may function effectively. For example, certain conventional corrosion inhibitor formulations have been limited to temperatures above 270° F. (132° C.) as they may not function effectively below this temperature, whereas temperatures in deepwater environments may be as low as 39° F. (4° C.) at or near an ocean floor.

Gas hydrates may form when water molecules become bonded together after coming into contact with certain “guest” gas or liquid molecules. Hydrogen bonding causes the water molecules to form a regular lattice structure, like a cage, that may be stabilized by the guest gas or liquid molecules entrapped within the lattice structure. The resulting crystalline structure may precipitate as a solid gas hydrate. Guest molecules may include any number of molecules, such as, for example, carbon dioxide, methane, butane, propane, hydrogen, helium, halogen, noble gases, and the like.

Gas hydrates are solids that may agglomerate in a fluid that may be flowing or substantially stationary, under certain temperature and pressure conditions. For example, gas hydrates may form during hydrocarbon production from a deepwater or a subterranean formation, in particular in pipelines and other equipment during production operations. Hydrates may impede or completely block flow of hydrocarbons or other fluid flowing through such pipelines. These blockages not only may decrease or stop production, potentially costing millions of dollars in lost production, but also may be very difficult and dangerous to mediate. Unless properly handled, gas hydrates may be volatile and/or explosive, potentially rupturing pipelines, damaging equipment, endangering workers, and/or causing environmental harm.

### BRIEF DESCRIPTION OF THE DRAWINGS

These drawings illustrate certain aspects of some of the embodiments of the present disclosure and should not be used to limit or define the disclosure.

FIG. 1 is a schematic illustration of an offshore production platform applicable to umbilical applications and compositions in accordance with some embodiments.

FIG. 2 is a side elevation view of an embodiment of an umbilical assembly in accordance with some embodiments.

FIG. 3 is a depiction of a molecule of a dual function inhibitor compound in accordance with some embodiments.

FIG. 4 is a depiction of an example the molecule of the dual function inhibitor compound of FIG. 3 in accordance with some embodiments.

FIG. 5 is a depiction of a molecule of a dual function inhibitor compound in accordance with some embodiments.

FIG. 6 is a depiction of an example of the molecule of the dual function inhibitor compound of FIG. 5 in accordance with some embodiments.

FIGS. 7A and 7B are graphical illustrations of the corrosion inhibition performance of dual function inhibitor compounds in accordance with some embodiments.

FIG. 8 is a depiction of a rocking cell test sample molecule of a dual function inhibitor compound in accordance with some embodiments.

### DETAILED DESCRIPTION

The present disclosure is directed to deepwater operations, and more particularly, to dual function inhibitor compounds for use as corrosion inhibitors and as low dosage hydrate inhibitors, or anti-agglomerates. The methods and compositions disclosed herein may be utilized in deepwater environments in subsea transmission lines that may transport or inject the dual function inhibitor compound into the well. In at least one embodiment, the dual function inhibitor compound may be injected into the well through an umbilical. As used herein, the terms “umbilical” and “umbilical line” are used interchangeably. In the well, the dual function inhibitor compound may mix with the liquid hydrocarbons, water, or gas, then flow back to the surface through production tubing, piping, or any appropriate drilling equipment where metal may be contacted or where hydrates may be formed.

Deepwater environments and definitions have changed through the decades as oil and gas capabilities and technology have transformed. As used herein, a deepwater environment may be defined as subsea wellheads at a depth of about 300 meters (“m”) or greater, whereas “ultra-deepwater” may be defined as subsea wellheads at depths of about 1500 m or greater.

Embodiments of a single compound disclosed herein may cover two functions: 1) corrosion inhibition, which may improve asset integrity; and 2) hydrate inhibition, which may improve flow assurance. The compounds disclosed herein may also be suitable for use in other oilfield applications, including subterranean applications and fracturing applications. For example, in addition to deepwater applications, embodiments disclosed herein may be applicable to horizontal, vertical, deviated, or otherwise nonlinear wellbores in any type of subterranean formation. Further, embodiments disclosed herein may be applicable to injection wells, monitoring wells, and production wells, including hydrocarbon or geothermal wells.

Metal surfaces in a wellbore that may be exposed to the dual function inhibitor compound may comprise a portion of a tubular or a wellbore tool. The surfaces may be comprised of various metals or metal alloys. For example, in some embodiments, the surfaces may be comprised of steel, wherein the steel surfaces may not be present in the wellbore per se, but may instead represent a structure in fluid communication with the wellbore. Further, pipelines, subsea riser structures, mixing tanks and storage vessels outside the wellbore may also be contacted with the dual function inhibitor compound, according to some embodiments of the present disclosure, in order to suppress corrosion in the presence of acids. Acidic fluids may be frequently utilized in the course of conducting various subterranean treatment operations. Illustrative uses of acidic fluids during subterranean operations include, for example, matrix acidizing of siliceous and/or non-siliceous formations, scale dissolution and removal operations, gel breaking, acid fracturing, and the like.

In some embodiments, the metal or metal alloy surface being exposed to the dual function inhibitor compound may comprise at least a portion of a subsea riser structure. In some embodiments, at least a portion of the subsea riser structure may be comprised of multiple types of metal alloys, such as steel alloys. That is, the steel surface may comprise more than one type of steel alloy. Accordingly, by contacting a subsea riser structure with embodiments of the dual function inhibitor compound disclosed herein, corrosion resulting from conveyance of acids, from a wellbore may be suppressed, including configurations in which multiple steel alloys are present in a given steel surface. Steel surfaces comprising more than one type of steel alloy may be present in not only subsea riser structures, but also in other types of tools and conduits when varying, mechanical or chemical properties are needed in different locations therein, such as umbilical lines.

Hydrate inhibitors may be grouped into three general classes: thermodynamic, kinetic, and anti-agglomerate. Thermodynamic hydrate inhibitors may operate by shifting the hydrate formation phase boundary away from the temperature and pressure conditions of a specific process by increasing the driving force required for formation of the hydrate. Kinetic hydrate inhibitors nay prevent or delay the nucleation of hydrates, thus limiting hydrate crystal size and growth. Anti-agglomerate hydrate inhibitors may prevent or otherwise disrupt the agglomeration of hydrates. Thermodynamic hydrate inhibitors may require high concentrations to be effective. Whereas, kinetic hydrate inhibitors and anti-agglomerate hydrate inhibitors may be effective at lower concentrations than thermodynamic inhibitors, and therefore may be termed low dosage hydrate inhibitors (“LDHI”). The compositions and method of using such compounds disclosed inhibit the formation of gas hydrate agglomerates.

The methods, compositions and systems disclosed herein comprise single compounds that may effectively function as both a corrosion inhibitor and a hydrate inhibitor, thereby functioning as a dual function inhibitor compound. In some embodiments, the dual function inhibitor compounds disclosed herein may comprise one or more lipophilic tails, a hydrophilic head, and a linking moiety. In some embodiments, the dual function inhibitor compounds disclosed herein may comprise a hydrophobic portion and a hydrophilic portion. In some embodiments, the dual function inhibitor compounds may be provided, used, and/or introduced as a salt. Further, methods are provided herein for adding one or more dual function inhibitor compounds to a fluid, wherein the fluid may comprise any one or more of water, a gas, a liquid hydrocarbon, and any combination thereof. In certain embodiments, the method may comprise adding to the fluid an effective amount of an embodiment of the dual function inhibitor compound to inhibit, retard, reduce, control, delay, and/or the like the formation of hydrate agglomerates.

The dual function inhibitor compounds, methods, and systems disclosed herein may, among other benefits, provide for enhanced anti-agglomeration properties and/or enhanced inhibition, retardation, mitigation, reduction, control, delay, and/or the like of agglomeration of hydrates and/or hydrate-forming compounds. In some embodiments, agglomeration of hydrates and/or hydrate-forming compounds may be reduced and/or inhibited to a greater degree than that achieved using other hydrate inhibition means.

It should also be noted that the dual function inhibition compounds, and methods of use thereof, as disclosed herein, may be used introduced into a fluid comprising one or more of water, a gas, a liquid hydrocarbon, or any combination thereof. Although listed separately from liquid hydrocarbon, the gas may in some embodiments include gaseous hydrocarbon, though the gas need not necessarily include hydrocarbon. In certain embodiments, the dual function inhibitor compound may be introduced into the fluid through a conduit or an injection point. In certain embodiments, one or more dual function inhibitor compounds may be introduced into a wellhead, a wellbore, a subterranean formation, a conduit, a vessel, and the like and may contact and/or be introduced into a fluid residing therein. In at least one embodiment, the wellhead, wellbore, subterranean formation, conduit, vessel, or the like may be in a deepwater environment. In at least one embodiment, the dual function inhibitor compounds may be introduced into the deepwater environment by way of an umbilical.

In certain embodiments, the fluid may be flowing, or it may be substantially stationary. In some instances, the fluid may contact metal surfaces. By introduction of the dual function inhibitor compound into the fluid, corrosion of the metal surface may be inhibited. In some instances, the fluid may be in a high-pressure, low-temperature environment such that hydrates form in the fluid. By introduction of the dual function inhibitor compound into the fluid, the formation of the hydrates may be inhibitor. In certain embodiments, hydrates may form in the fluid when the pressure of the environment in which the fluid flows or resides is in the range from about 14.7 psi to about 20,000 psi. In certain embodiments, hydrates may form in the fluid when the temperature of the environment in which the fluid flows or resides is in the range from about 0° C. (32° F.) to about 30° C. (86° F.). In certain embodiments, the formation of hydrates in a fluid may depend on both the pressure and the temperature of the fluid and/or the environment in which the fluid is located. For example, at lower temperatures (e.g., below about 5° C. (41° F.)), methane hydrates may form over a wide range of pressures (e.g., above about 400 psi). Conversely, at higher pressures (e.g., above about 1400 psi), methane hydrates may form over a wide range of temperatures (e.g., up to about 15° C. (59° F.)).

In certain embodiments, the fluid may be within a vessel, or within a conduit (e.g., a conduit that may transport the fluid), or within a subterranean formation, or within a wellbore penetrating a portion of the subterranean formation, and/or within a wellhead of a wellbore. Examples of conduits include, but are not limited to, pipelines, production piping, subsea tubulars, process equipment, and the like as used in industrial settings and/or as used in the production of oil and/or gas from a subterranean formation, and the like. The conduit may in certain embodiments penetrate at least a portion of a subterranean formation, as in the case of an oil and/or gas well. In some embodiments, the wellhead may be in a deepwater environment. In particular embodiments, the conduit may be a wellhead, a wellbore, or may be located within a wellbore penetrating at least a portion of a subterranean formation. Such oil and/or gas well may, for example, be a subsea well (e.g., with the subterranean formation being located below the sea floor), or it may be a surface well (e.g., with the subterranean formation being located belowground). In some embodiments, the subsea well may be in a deepwater environment.

In some embodiments, the dual function inhibitor compounds of the present disclosure initially may be incorporated into a composition prior to being introduced into the fluid. The composition may be any suitable composition in which the dual function inhibitor compound may be included. For example, the composition may include a solvent for the dual function inhibitor compound. Suitable solvents include, for example, any alcohol, methanol, isopropyl alcohol, glycol, ethylene glycol, any organic solvent, toluene, xylene, monobutyl ether, hexane, cyclohexane, and/or any combination thereof.

In some embodiments, the dual function inhibitor compounds may be introduced into a fluid in any suitable amount for corrosion and/or hydrate inhibition. In some embodiments, the dual function hydrate inhibitor compounds may be introduced into the fluid in an amount from about 0.1% to about 10% by volume based on the volume of water in the fluid (or in other words, about 0.1% to about 10% by volume based on water cut). In various embodiments, the dual function inhibitor compounds of the present disclosure may be used as low dosage hydrate/corrosion inhibitors such that an effective amount of one or more dual function inhibitor compounds for inhibiting, retarding, mitigating, reducing, controlling, and/or delaying corrosion and agglomeration of hydrates may be as low as any of about 0.1%, about 0.25%, about 0.50%, about 0.75%, about 1.00%, about 1.25%, about 1.50%, about 1.75%, about 2.00%, about 2.25%, and about 2.50% by volume based on water cut. An effective amount may be as high as any of: about 0.5%, about 1.0%, about 1.5%, about 2.0%, about 2.5%, about 3.0%, about 3.5%, about 4.0%, about 4.5%, about 5.0%, about 5.5%, about 6.0%, about 6.5%, about 7.0%, about 7.5%, about 8.0%, about 8.5%, about 9.0%, about 9.5%, and about 10.0% by volume based on water cut. Thus, in some embodiments, an effective amount of dual function inhibitor compounds of the present disclosure for inhibiting, retarding, mitigating, reducing, controlling, and/or delaying corrosion and agglomeration of hydrates may be about 0.1% to about 5.5% by volume based on water cut of the fluid; in other embodiments, about 0.1% to about 3.0% by volume based on water cut of the fluid; in other embodiments, about 0.25% to about 2.5% by volume based on water cut of the fluid; and in other embodiments, about 0.5%, to about 2.0% by volume based on water cut of the fluid.

In some embodiments, the dual function inhibitor compounds may be introduced into various fluids having different water cuts (i.e., the ratio of the volume of water in the fluid to the total volume of the fluid). For example, in some embodiments the water cut of the fluid may be about 1% to about 65%. In other embodiments, the water cut may be as low as any one of: about 20%, about 25%, about 30%, about 35%, about 40%, about 45%, about 0.50%, about 55%, about 60%, and about 65%; while the water cut may be as high as any one of: about 35%, about 40%, about 45%, about 50%, about 55%, about 60%, about 65%, about 70%, about 75%, about 80%, about 85%, about 90%, and about 95%. In certain embodiments, a fluid may have a water cut of about 30% or more, about 35% or more, about 40% or more, about 45% or more, about 50% or more, about 55% or more, or about 60% or more, up to about 99%. In yet other embodiments, one or more dual function inhibitor compounds may be introduced into or contact a fluid with any water cut ranging from about 1% to about 99%.

In certain embodiments, the dual function inhibitor compounds may be introduced into a wellhead of a wellbore penetrating at least a portion of the subterranean formation, a wellbore, a subterranean formation, a vessel, and/or a conduit (and/or into a fluid within any of the foregoing) using any method or equipment known in the art. In other embodiments, a dual function compound of the present disclosure may be injected into a portion of a subterranean formation using an annular space or capillary injection system to continuously introduce the hydrate inhibitor compound into the formation. In some embodiments, the capillary injection may include an umbilical with the wellhead in a deepwater environment. In certain embodiments, a composition comprising a dual function inhibitor compound of the present disclosure may be circulated in the wellbore using the same types of pumping systems and equipment at the surface that are used to introduce treatment fluids or additives into a wellbore penetrating at least a portion of the subterranean formation.

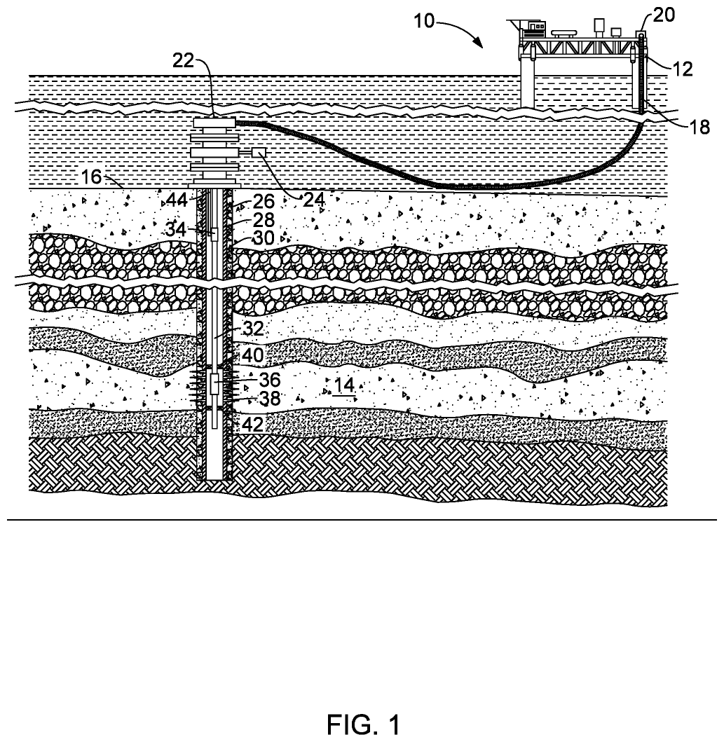

FIG. 1 is a schematic illustration of an offshore production platform applicable to embodiments of umbilical applications and treatment fluids disclosed herein. A semi-submergible production platform 12 may be positioned generally above a submerged oil and gas formation 14 located below a sea floor 16. An umbilical assembly 18 may extend from control unit 20 on platform 12 to a subsea wellhead 22 at sea floor 16. Umbilical assembly 18 may be flexible and able to adopt to the ocean currents as well as any drift of the surface installation 12. The dual function inhibitor compound may be injected into the subsea environment through the umbilical assembly 18. A subsea intensifier 24 may be operably associated with subsea wellhead 22 and may be in fluid communication with umbilical assembly 18. A wellbore 26 may extend from wellhead 22 through various earth strata including formation 14. A casing 28 may be cemented within wellbore 26 by cement 30. A production tubing 32 may be positioned within casing 28. Tubing string 32 may include a subsurface safety valve 34. In addition, tubing string 32 may have a sand control screen 36 positioned proximate subsea wellhead 14 such that production fluids may be produced through perforations 38 and into tubing string 32. A pair of packers 40, 42 may isolate the production interval between tubing string 32 and casing 28. A hydraulic control line 44 may extend from subsea intensifier 24 to subsurface safety valve 34. Even though FIG. 1 depicts a vertical well, it should be noted by one skilled in the art that the assembly may be equally well-suited for use in deviated wells, inclined wells, horizontal wells and other types of well configurations. In addition, even though FIG. 1 depicts a production well, it should be noted by one skilled in the art that the assembly may be equally well-suited for use in injection wells.

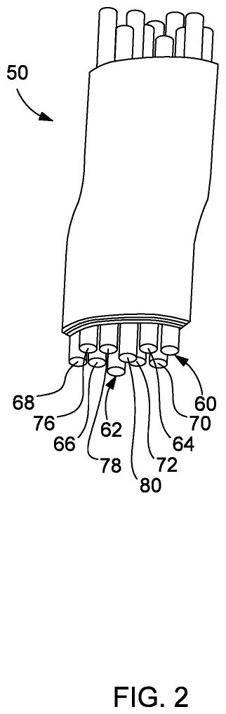

FIG. 2 is a side elevation view of an embodiment of an umbilical assembly in accordance with some embodiments. The umbilical assembly 50 may include a plurality of passageways 60 housed within. Passageways 60 may be fluid passageways 62, such as hydraulic fluid passageways 64, 66 or production fluid passageways 68, 70, 72. Fluid passageways 62 may comprise a protective sheath defining a fluid cavity that may be compatible with a variety of fluids, including the dual function inhibitor compounds as disclosed herein. In addition, some passageways, such as passageways 76, 78, 80 may house electrical power conduits or electrical signal conduits. Electrical power conduits and electrical signal conduits may include one or more copper wires, multi-conductor copper wires, braided wires, or coaxial woven conductors bounded in a protective sheath.

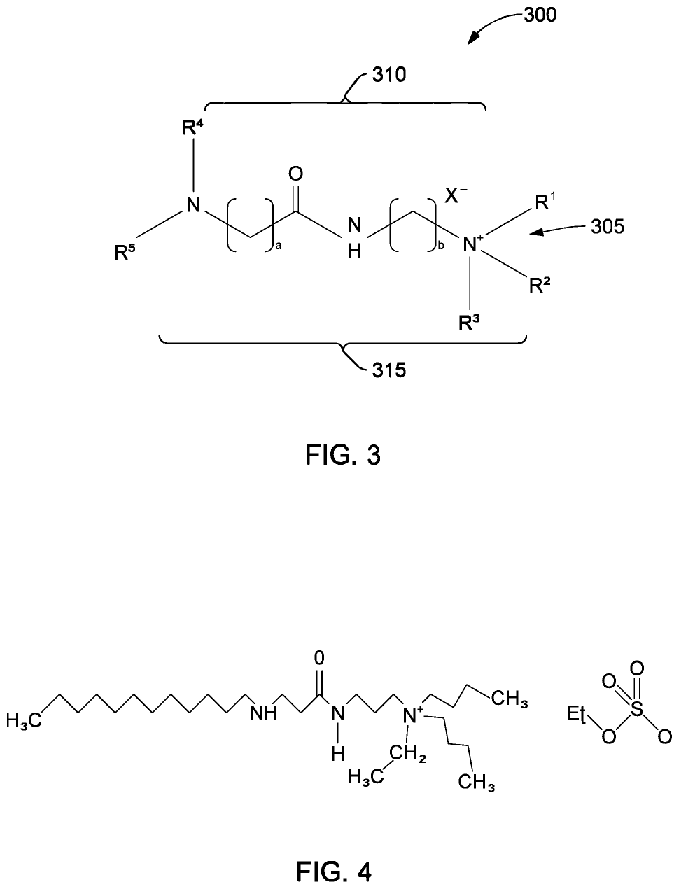

In some embodiments, the dual function inhibitor compounds disclosed herein may be utilized in methods that comprise both corrosion inhibition and hydrate inhibition in a deepwater environment. More specifically, methods are provided herein for adding one or more dual function inhibitor compounds to a fluid, wherein the dual function inhibitor compounds may comprise at least one compound having a structural formula of FIGS. 3, 3A, 4, 4A, and 6, wherein each R¹ and R² is independently a C₁ to C₆ hydrocarbon chain, wherein R³ is selected from the group consisting of hydrogen and any C₁ to C₆ hydrocarbon chain, wherein R⁴ is selected from the group consisting of hydrogen and any C₁ to C₆ hydrocarbon chain, wherein R⁵ is a C₁ to C₅₀ hydrocarbon chain, wherein X⁻ is a counter anion, and wherein each of a and h is independently an integer from 1 to 10.

The method may further comprise some embodiments wherein X may be selected from the group consisting of a carboxylate, a halide, a sulfate, an organic sulfonate, a hydroxide, and any combinations thereof. The method may further comprise an embodiment wherein each of R⁴ and R⁵ may be a C₁ to C₅₀ hydrocarbon chain resulting from a reaction between an acrylate or a methacrylate and an amine, wherein the amine may be selected from the group consisting of: a synthetic primary or secondary amine selected from the group consisting of: butylamine, hexylamine, octylamine, dodecylamine, N-methyldodecylamine, N-methyloctylamine, didodecylamine, and any combination thereof a primary or secondary fatty amine derived from one or more fatty acids selected from the group consisting of: corn oil, canola oil, coconut oil, safflower oil, sesame oil, palm oil, cottonseed oil, soybean oil, olive oil, sunflower oil, hemp oil, wheat germ oil, palm kernel oil, vegetable oil, caprylic acid, capric acid, lauric acid, myristic acid, myristoleic acid, palmitic acid, palmitoleic acid, stearic acid, sapienic acid, elaidic acid, vaccenic acid, linoleic acid, arachidic acid, arachidonic acid, eicosapentaenoic acid, erucic acid, docosahexaenoic acid, behenic acid, lignoceric acid, cerotic acid, oleic acids (cis- and trans-), and any combination thereof and any combination thereof.

The method may further comprise reacting (i) an alkylating agent and (ii) a second intermediate resulting from a reaction between a dialkylaminoalkylamine and a first intermediate, wherein the first intermediate may result from a reaction between an acrylate or a methacrylate and an amine embodiments to produce the dual function inhibitor compound.

In some embodiments, the method may comprise introducing one or more dual function inhibitor compounds into a fluid comprising a hydrocarbon and water such that the one or more dual function inhibitor compounds inhibit hydrate formation in the fluid.

FIG. 3 is a depiction of a molecule of a dual function inhibitor compound in accordance with some embodiments. In certain embodiments, the cation moiety in the dual function inhibitor compounds of the present disclosure may be bonded to other moieties of the dual function inhibitor compound. For example, as shown with respect to the hydrophilic head 305 of the dual function inhibitor compound 300. In certain embodiments, the cation moiety may be substantially of the composition —R¹R²R³N⁺—. Each of R¹, R², and R³ may independently comprise either a hydrogen atom or a C₁ to C₆ hydrocarbon chain. As used herein, a “hydrocarbon chain” may, unless otherwise specifically noted, be branched, unbranched, non-cyclic, and/or cyclic; substituted or unsubstituted (that is, it may or may not contain one or more additional moieties or functional groups in place of one or more hydrogen atoms in the hydrocarbon chain); and/or saturated or unsaturated. Furthermore, as used herein, the nomenclature “Cₓ to C_{y}” refers to the number of carbon atoms in the hydrocarbon chain (here, ranging from x toy carbon atoms). As used herein, “independently” refers to the notion that the preceding items may be the same or different.

In certain embodiments, R¹, R², and/or R³ may be a hydrogen atom. In certain embodiments, only one of R¹, R², and R³ may be a hydrogen atom. In those embodiments, the cation moiety may be a tertiary ammonium cation moiety, in other embodiments, none of R¹, R², and/or R³ may be a hydrogen atom. In those embodiments, each of R¹, R², and R³ may independently comprise a C₁ to C₆ hydrocarbon chain, and the cation moiety may be quaternary ammonium cation moiety. In such embodiments wherein at least one of R¹, R², and/or R³ comprises a C₁ to C₆ hydrocarbon chain, the hydrocarbon chain may comprise any one or more hydrocarbon groups selected from the group consisting of: alkyl, alkenyl, alkynyl, aryl, arylalkyl, arylalkenyl, alkyl aryl, alkenylaryl, and any combination thereof. In such embodiments, any one or more of R¹, R², and R³ may be branched, unbranched, non-cyclic, cyclic, saturated, and/or unsaturated. In certain embodiments, each of R¹, R², and R³ may independently comprise (i) as few as any one of: 1, 2, 3, 4, 5, and 6 carbon atoms, and (ii) as many as one of: 2, 3, 4, 5, and 6 carbon atoms. For example, suitable ranges of carbon atoms in each of R¹, R², and R³ according to various embodiments of the present disclosure include, but are not limited to, 1 to 2, 1 to 3, 1 to 4, 1 to 5, 1 to 6, 2 to 4, 3 to 5, and 4 to 6, and the like.

In some embodiments, any one or more of R¹, R², and R³ may comprise a C₁ to C₆ alkyl chain. In some embodiments, any one or more of R¹, R², and R³ may comprise a C₂ to C₆ alkenyl or alkynyl chain (in which case at least 2 carbon atoms are necessary to form an alkenyl or alkynyl chain). In some embodiments, any one or more of R¹, R², and R³ may comprise a C₃ to C₆ cyclic moiety (in which case at least 3 carbon atoms are necessary to form a cyclic moiety). In certain embodiments, any one or more of R¹, R², and R³ may be substituted (e.g., it may include any one or more functional groups in addition to the hydrocarbon groups described above), so long as the cation moiety remains hydrophilic.

The dual function inhibitor compounds disclosed herein may comprise one or more lipophilic tails. As shown in FIG. 3, the dual function inhibitor compound 300 may comprise two lipophilic tails R⁴ and R⁵. In certain embodiments, the lipophilic tails of the dual function inhibitor compounds of the present disclosure may each independently be selected from the group consisting of a hydrocarbon and C₁ to C₅₀ hydrocarbon chain. In certain embodiments, the hydrocarbon chain of the lipophilic tail(s) may be branched or unbranched, cyclic or non-cyclic, saturated or saturated, and/or may be any one or more of alkyl, alkenyl, alkenyl, and aryl groups, and/or any combination thereof. In certain embodiments, the lipophilic tail(s) may further optionally be substituted with any one or more functional groups, so long as such substituted functional group(s) do not alter the lipophilic and/or hydrophobic nature of the lipophilic tail(s). In certain embodiments, each of the lipophilic tails may independently/comprise (i) as few as any one of: 1, 2, 3, 4, 5, 6, 7, 8, 9, 10, 11, 12, 13, 14, 15, 16, 17, 18, 19, and 20 carbon atoms, and (ii) as many as any one of: 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, and 50 carbon atoms. For example, suitable ranges of carbon atoms in the lipophilic tail(s) according to various embodiments of the present disclosure include, but are not limited to, 1 to 5, 3 to 5, 4 to 8, 5 to 15, 8 to 18, 12 to 16, 8 to 20, 10 to 20, 15 to 20, and the like. It may be appreciated by one of ordinary skill in the art having the benefit of the present disclosure that even in such embodiments, additional lipophilic tails may be included in the dual function inhibitor compound (e.g., at a point along the backbone 315 of the dual function inhibitor compound 300), wherein X⁻ is a counter anion, and wherein each of a and b is independently an integer from 1 to 10.

The dual function inhibitor compounds disclosed herein may further comprise a linking moiety. As used herein, “linking moiety” refers to any portion of the hydrate inhibitor compound that provides spacing between the hydrophilic head and the lipophilic tail(s). In certain embodiments, one or more lipophilic tails may be connected to the hydrophilic head via the linking moiety. For example, in the dual function inhibitor compound 300, lipophilic tails R⁴ and R⁵ may be connected to hydrophilic head 305 via linking moiety 310. In certain embodiments, the linking moiety may provide sufficient spacing so that the hydrate inhibitor compound maintains an overall substantially amphiphilic character.

In some embodiments, the linking moiety may each comprise one or more hydrocarbon chains of any length, branched or unbranched, and/or saturated or unsaturated (so long as the overall hydrate inhibitor compound maintains amphiphilic character). Hydrocarbon chain lengths may include C₁ to C₂₀ chains or longer. In certain embodiments, the linking moiety may be any one or more of methyl, ethyl, propyl, butyl, pentyl, hexyl, heptyl, octyl, nonyl, decyl, etc. in certain embodiments, the linking moiety may be substituted such that it includes any kind and any number of functional groups (so long as the hydrate inhibitor compound maintains both hydrophobic and hydrophilic portions). In such embodiments, the one or more functional groups that may be included on the linking moiety according to some embodiments should not adversely affect the hydrophilic nature of a hydrophilic head, nor should they adversely affect the lipophilic nature of the lipophilic tail(s). Examples of suitable functional groups that may be included in the linking moiety, the lipophilic tails), and/or the R-groups (R¹, R², R³) as disclosed herein may include any one or more of: an ester, ether, amine, sulfonamide, amide, ketone, carbonyl, isocyanate, urea, urethane, and any combination thereof in some embodiments, the one or more functional groups on the linking moiety may include any group capable of reacting with an amine, provided that functional group's inclusion in the linking moiety allows the dual function inhibitor compound to maintain its amphiphilic character.

For example, the dual function inhibitor compound 300 of FIG. 3 may include example linking moiety 310, comprising an amide group as well as two alkyl chains of the general formulas CₐH₂ₐ and C_{b}H_{2b} on either side of the amide group. In certain embodiments, each of a and b may independently be an integer from 1 to 10. In certain embodiments, each alkyl chain in the linking moiety may comprise (1) as few as any one of 1, 2, 3, 4, 5, 6, 7, 8, 9, and 10 carbon atoms, and (ii) as many as any one of: 2, 3, 4, 5, 6, 7, 8, 9, and 10 carbon atoms.

The dual function inhibitor compounds disclosed herein may instead or in addition be characterized as reaction products. For instance, in some embodiments disclosed herein dual function inhibitor compounds are provided that may be characterized as reaction products of: (1) a dialkylaminoalkylamine having the general formula H₂N—(CH₂)_{b}—NR¹R² and (2) a first intermediate formed as the reaction product of one or more unsaturated carboxylic acids or esters containing an alkene chain (e.g., acrylates) and an amine. In some embodiments, the “dialkyl” groups of the dialkylaminoalkylamine may be either the same or different, and R¹ and R² of the cation moiety may depend upon, among other factors, the identity of the dialkyl groups of the dialkylaminoalkylamine. The length of the “alkyl” chain (i.e., (CH₂)_{b}) of the dialkylaminoalkylamine may vary from (CH₂)₁ to (CH₂)₁₀, and the length of an alkyl chain in the linking moiety having the general formula C_{b}H_{2b} may depend upon, among other factors, the length of the alkyl chain of the dialkylaminoalkylamine. In some embodiments, the unsaturated carboxylic acids or esters containing an alkene chain may be an alkyl alkenoate (e.g., an alkyl methacrylate, an alkyl acrylate (for example, methyl acrylate)), an alkenoic acid (e.g., acrylic acid), and any combination thereof. In some embodiments, the length of an alkyl chain in the linking moiety, having the general formula CₐH₂ₐ, may depend upon, among other factors, the identity of the unsaturated carboxylic acid or ester.

In other embodiments, the amine may have one or more hydrocarbon chains each of a length from C₁ to C₅₀, and the lipophilic tails R⁴ and R⁵ of the dual function inhibitor compound may depend upon, among other factors, the identity of the hydrocarbon chains. In certain embodiments, the amine may comprise one or more functional groups and a portion of the functional group may be included in the lipophilic tails R⁴ and R⁵ of the dual function inhibitor compound. Suitable amines for reaction may include, but are not limited to, any primary or secondary fatty amine derived from one or more fatty acids selected from the group consisting of corn oil, canola oil, coconut oil, safflower oil, sesame oil, palm oil, cottonseed oil, soybean oil, olive oil, sunflower oil, hemp oil, wheat germ oil, palm kernel oil, vegetable oil, caprylic acid, capric acid, lauric acid, stearic acid, myristic acid, myristoleic acid, palmitic acid, palmitoleic acid, stearic acid, sapienic acid, elaidic acid, vaccenic acid, linoleic acid, arachidic acid, arachidonic acid, eicosapentaenoic acid, erucic acid, docosahexaenoic acid, behenic acid, lignoceric acid, cerotic acid, oleic acids (cis- and trans-), and any combination thereof. Suitable amines for reaction also may include, but are not limited to, any synthetic primary or secondary amine including, but not limited to, butylamine, amine, hexylamine, octylamine, dodecylamine, N-methyldodecylamine, N-methyloctylamine, didodecylamine and the like, and any combination thereof.

In some embodiments, the reaction product of (1) the dialkylaminoalkylamine and (2) the first intermediate may form a second intermediate that may further be reacted with (3) one or more alkylating agents. In such embodiments, R³ of the cation moiety may depend upon, among other factors, the alkyl group of the alkylating agent(s). In other embodiments, the one or more alkylating agents may be a carbonate, a halide, a sulfate, an organic sulfonate, a hydroxide, and/or any combination thereof.

FIG. 4 is a depiction of an example of the molecule of the dual function inhibitor compound of FIG. 3 in accordance with some embodiments. The dual function inhibitor molecule of FIG. 4 may perform as both a corrosion inhibitor and a hydrate inhibitor and may be suitable for subsea application via umbilical lines from the surface to the ocean floor. The dual function inhibitor molecules may function effectively in deepwater environments where temperatures mar be as low as 39° F. (4° C.) at or near an ocean floor.

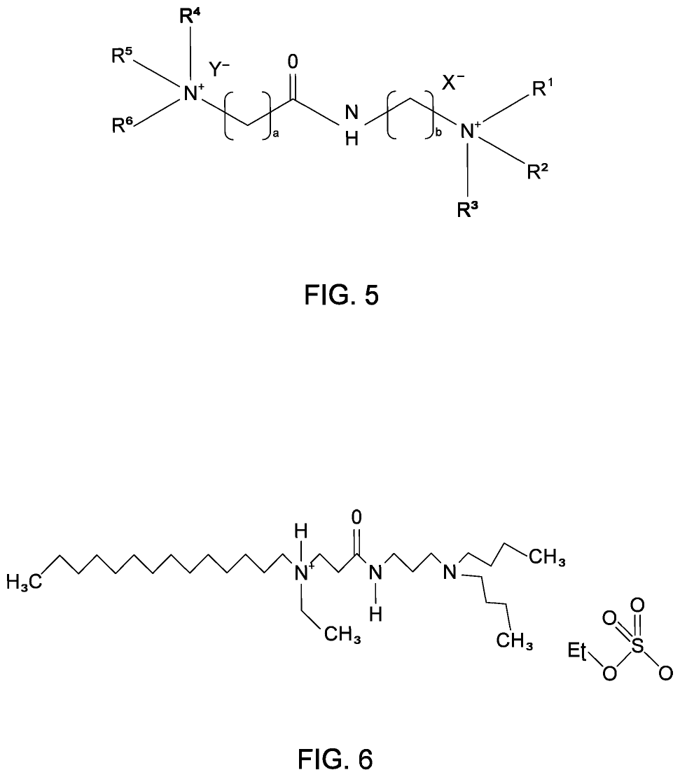

FIG. 5 is a depiction of a molecule of a dual function inhibitor compound in accordance with some embodiments. Some embodiments may comprise long chain hydrocarbons, wherein the long chain hydrocarbon may be a C₆ to C₅₀ long chain hydrocarbon. Amines may be derived from one or more fatty acids selected from the group consisting of: corn oil, canola oil, coconut oil, safflower oil, sesame oil, palm oil, cottonseed oil, soybean oil, olive oil, sunflower oil, hemp oil, wheat germ oil, palm kernel oil, vegetable oil, tallow oil, or combinations thereof. In other embodiments, anionic counter ions may be chosen from the group consisting of: a carboxylate, a halide, a sulfate, an organic sulfonate, a hydroxide, or any combination thereof. In some embodiments, the dual function inhibition compounds may be applied independently as a corrosion inhibitor, a hydrate inhibitor, or combinations thereof, for both onshore and offshore applications.

Referring to FIG. 5, in some embodiments, the cation moieties in the dual function inhibitor compound 400 disclosed herein may be bonded to other moieties of the dual function inhibitor compound 400, for example, as shown with respect to the cation moieties 402, 404 in FIG. 4. In some embodiments, the cation moieties 402, 404 may be substantially of the composition —R¹R²R³N⁺— and —R⁴R⁵R⁶N⁺—. Each of R¹, R², and R³ may independently include a C₁ to C₆ hydrocarbon chain, wherein R⁴ may be selected from the group consisting of hydrogen and a C₁ to C₅₀ hydrocarbon chain, wherein each of R⁵ and R⁶ may be independently selected from the group consisting of hydrogen and a C₁ to C₅₀ hydrocarbon chain, wherein X⁻ and Y⁻ are counter anions, and wherein each of a and b may independently be an integer from 1 to 10. In one or more embodiments described above, X⁻ and Y⁻ may be selected from the group consisting of: a carboxylate, a halide, a sulfate, an organic sulfonate, a phosphate, a phosphonate, a hydroxide, and any combination thereof.

As used herein, a “hydrocarbon chain” may be, unless otherwise specifically noted, branched, unbranched, non-cyclic, and/or cyclic; substituted or unsubstituted (that is, it may or may not contain one or more additional moieties or functional groups in place of one or more hydrogen atoms in the hydrocarbon chain); and/or it may be saturated or unsaturated. Furthermore, as used herein, the nomenclature “Cₓ to C_{y}” refers to the number of carbon atoms in the hydrocarbon chain (here, ranging from x to y carbon atoms). As used herein, “independently” refers to the notion that the preceding items may be the same or different.

In certain embodiments, R¹, R², and/or R³ may independently include a C₁ to C₆ alkyl chain. In such embodiments wherein at least one of R¹, R², and/or R³ includes a C₁ to C₆ hydrocarbon chain, the hydrocarbon chain may include any one or more hydrocarbon groups selected from the group consisting of: alkyl, alkenyl, alkynyl, aryl, arylalkyl, arylalkenyl, alkylaryl, alkenylaryl, and any combination thereof. In such embodiments, any one or more of R¹, R², and R³ may be branched, unbranched, non-cyclic, cyclic, saturated, and/or unsaturated. In certain embodiments, each of R¹, R², and R³ may independently include (i) as few as any one of: 1, 2, 3, 4, 5, and 6 carbon atoms, and (ii) as many as one of: 2, 3, 4, 5, and 6 carbon atoms. For example, suitable ranges of numbers of carbon atoms in each of R¹, R², and R³ according to various embodiments of the present disclosure include, but are not limited to, 1 to 2, 1 to 3, 1 to 4, 1 to 5, 1 to 6, 2 to 4, 3 to 5, and 4 to 6, and the like.

In some embodiments, any one or more of R¹, R², and R³ may include a C₁ to C₆ alkyl chain. In some embodiments, any one or more of R¹, R², and R³ may include a C₂ to C₆ alkenyl or alkynyl chain (in which case at least 2 carbon atoms are necessary to form an alkenyl or alkynyl chain). In some embodiments, any one or more of R¹, R², and R³ may include a C₃ to C₆ cyclic moiety (in which case at least 3 carbon atoms are necessary to form a cyclic moiety). In certain embodiments, any one or more of R¹, R², and R³ may be substituted (e.g., may include any one or more functional groups in addition to the hydrocarbon groups described above), so long as the cation moiety remains hydrophilic.

In some embodiments, R⁵ and R⁶ may independently include a C₁ to C₅₀ hydrocarbon chain. In certain embodiments, R⁴ may be a hydrogen atom. In those embodiments, the cation moiety —R⁴R⁵R⁶N⁺— may be a tertiary ammonium cation moiety. In other embodiments, R⁴ may not be a hydrogen atom. In those embodiments, each of R⁴, R⁵, and R⁶ may independently include a C₁ to C₅₀ hydrocarbon chain, and the cation moiety —R⁴R⁵R⁶N⁺— may be a quaternary ammonium cation moiety. In such embodiments wherein at least one of R⁴, R⁵, and R⁶ include a C₁ to C₅₀ hydrocarbon chain, the hydrocarbon chain may include any one or more hydrocarbon groups selected from the group consisting of: alkyl, alkenyl, alkynyl, aryl, arylalkyl, arylalkenyl, alkylaryl, alkenylaryl, and any combination thereof. In such embodiments, any one or more of R⁴, R⁵, and R⁶ may be branched, unbranched, non-cyclic, cyclic, saturated, and/or unsaturated. In certain embodiments, each of R⁴, R⁵, and R⁶ may independently include (i) as few as any one of: 1, 2, 3, 4, 5, 6, 7, 8, 9, 10, 11, 12, 13, 14, 15, 16, 17, 18, 19, and 20 carbon atoms, and (ii) as many as one of: 35, 36, 37, 38, 39, 40, 41, 42, 43, 44, 45, 46, 47, 48, 49, and 50 carbon atoms. For example, suitable ranges of numbers of carbon atoms in each of R⁴, R⁵, and R⁶ according to various embodiments of the present disclosure include, but are not limited to, 1 to 50, 1 to 40, 1 to 30, 1 to 20, 1 to 10, 1 to 6, 2 to 10, and 5 to 10, and the like.

In some embodiments, any one or more of R⁴, R⁵, and R⁶ may include a C₁ to C₅₀ alkyl chain. In certain embodiments, any one or more of R⁴, R⁵, and R⁶ may be substituted (e.g., may include any one or more functional groups in addition to the hydrocarbon groups described above).

The dual function inhibitor compound 400, as disclosed herein, may further include one or more lipophilic tails. For example, with reference to FIG. 5, R⁴, R⁵, and/or R⁶ of the dual function inhibitor compound 400 may include a lipophilic tail. In some embodiments, only one of R⁴, R⁵, and R⁶ may be a lipophilic tail. In certain embodiments, the hydrocarbon chain of the lipophilic tail(s) may be branched or unbranched, cyclic or non-cyclic, saturated or saturated, and/or may be any one or more of alkyl, alkenyl, alkynyl, and aryl groups, and/or any combination thereof. In certain embodiments, the lipophilic tail(s) may further optionally be substituted with any one or more functional groups, so long as such substituted functional group(s) do not alter the lipophilic and/or hydrophobic nature of the lipophilic tail(s). In certain embodiments, each of the lipophilic tails may independently include (i) as few as any one of: 1, 2, 3, 4, 5, 6, 7, 8, 9, 10, 11, 12, 13, 14, 15, 16, 17, 18, 19, and 20 carbon atoms, and (ii) as many as any one of: 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, and 50 carbon atoms. For example, suitable ranges of numbers of carbon atoms in the lipophilic tail(s) according to various embodiments of the present disclosure include, but are not limited to 1 to 5, 3 to 5, 4 to 8, 5 to 15, 8 to 18, 12 to 16, 8 to 20, 10 to 20, 15 to 20, and the like. It will be appreciated by one of ordinary skill in the art having the benefit of the present disclosure that even in such embodiments, additional lipophilic tails could be included in the dual function inhibitor compound (e.g., at a point along the backbone 408 of the dual function inhibitor compound 400).

The dual function inhibitor compound 400 of the present disclosure may further include a linking moiety. As used herein, “linking moiety” refers to any portion of the dual function inhibitor compound that provides spacing between the cation moieties and/or the lipophilic tail(s). In certain embodiments, one or more lipophilic tails may be connected to the cation moieties via the linking moiety. In some embodiments, two or more cation moieties may be connected to each other via a linking moiety. For example, in the dual function inhibitor compound 400 shown in FIG. 5, first cation moiety 402 is connected to second cation moiety 404 via linking moiety 406.

In certain embodiments, the linking moiety may each include one or more hydrocarbon chains of any length, branched or unbranched, and/or saturated or unsaturated (so long as the overall dual function inhibitor compound maintains amphiphilic character). Hydrocarbon chain lengths include C₁ to C₅₀ chains or longer. In certain embodiments, the linking moiety may be any one or more of methyl, ethyl, propyl, butyl, pentyl, hexyl, heptyl, octyl, nonyl, decyl, etc. In certain embodiments, the linking moiety may be substituted such that it includes any kind and any number of functional groups (so long as the dual function inhibitor compound maintains both hydrophobic and hydrophilic portions). In such embodiments, the one or more functional groups that may be included on the linking moiety according to some embodiments should not adversely affect the hydrophilic nature of a hydrophilic head, nor should they adversely affect the lipophilic nature of the lipophilic tail(s). Examples of suitable functional groups that may be included in the linking moiety, the lipophilic tail(s), and/or the R-groups (R¹, R², R³, R⁴, R⁵, R⁶) of the present disclosure may include any one or more of: an ester, ether, amine, sulfonamide, amide, ketone, carbonyl, isocyanate, urea, urethane, and any combination thereof. In some embodiments, the one or more functional groups on the linking moiety may include any group capable of reacting with an amine, provided that functional group's inclusion in the linking moiety allows the hydrate inhibitor compound to maintain its amphiphilic character.

For example, the dual function inhibitor compound 400 of FIG. 5 includes example linking moiety 406 including an amide group as well as two alkyl chains of the general formulas CₐH₂ₐ and C_{b}H_{2b} on either side of the amide group. In certain embodiments, each of a and b may independently be an integer from 1 to 10. In certain embodiments, each alkyl chain in the linking moiety may include (i) as few as any one of: 1, 2, 3, 4, 5, 6, 7, 8, 9, and 10 carbon atoms, and (ii) as many as any one of: 2, 3, 4, 5, 6, 7, 8, 9, and 10 carbon atoms.

FIG. 6 is a depiction of an example of the molecule of the dual function inhibitor compound of FIG. 5 in accordance with some embodiments. The dual function inhibitor molecule of FIG. 6 may perform as both a corrosion inhibitor and a hydrate inhibitor and may be suitable for subsea application via umbilical lines from the surface to the ocean floor. The dual function inhibitor molecules may function effectively in deepwater environments where temperatures may be as low as 39° F. (4° C.) at or near an ocean floor.

Accordingly, the methods, compositions, and systems disclosed herein may be directed to corrosion inhibition and hydrate inhibition in a subsea well. The methods, compositions, and systems may include any of the various features of the methods, compositions, and systems disclosed herein, including one or more of the following statements:

Statement 1. A method may comprise: introducing one or more dual function inhibitor compounds through an umbilical into a deepwater environment such that the one or more dual function inhibitor compounds are introduced into a fluid in the deepwater environment, wherein the one or more dual function inhibitor compounds have the following structural formula:

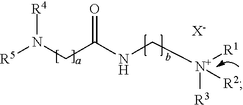

wherein each dual function inhibitor compound is both a corrosion inhibitor and a hydrate inhibitor.

Statement 2. The method of statement 1, wherein each of R¹, R², and R³ is each independently a C₁ to C₆ hydrocarbon chain, wherein the C₁ to C₆ hydrocarbon chain comprises one or more hydrocarbon groups selected from the group consisting of alkyl, alkenyl, alkynyl, aryl, arylalkyl, arylalkenyl, alkylaryl, alkenylaryl, and combinations thereof; wherein R⁴ and R⁵ are each independently selected from the group consisting of a hydrocarbon and a C₁ to C₅₀ hydrocarbon chain; and wherein X⁻ is a counter anion, and wherein each of a and b is independently an integer from 1 to 10.

Statement 3. The method of statement 1 or 2, wherein any one or more of R¹, R², and R³ is branched, unbranched, non-cyclic, cyclic, saturated, unsaturated, or combinations thereof.

Statement 4. The method of any of the preceding statements, wherein R⁴ and R⁵ is branched, unbranched, non-cyclic, cyclic, saturated, unsaturated, or combinations thereof.

Statement 5. The method of any of the preceding statements, wherein R⁴ and R⁵ is selected from the group consisting of alkyl, alkenyl, aryl, and combinations thereof.

Statement 6. The method of any of the preceding statements, wherein the dual function inhibitor compounds comprise a linking moiety.

Statement 7. The method of statement 6, wherein the linking moiety comprises one or more hydrocarbon chains, wherein the hydrocarbon chains comprise C₁ to C₂₀ chains or longer.

Statement 8. The method of statement 6 or 7, wherein the linking moiety is selected from the group consisting of methyl, ethyl, propyl, butyl, pentyl, hexyl, heptyl, octyl, nonyl, decyl, and combinations thereof.

Statement 9. The method of any of the preceding statements, wherein the dual function inhibitor compound comprises a hydrophobic portion and a hydrophilic portion.

Statement 10. The method of any of the preceding statements, further comprising contacting a metal surface with the fluid after introduction of the one or more dual function inhibitor compounds.

Statement 11. The method of statement 10, further comprising suppressing corrosion of the metal surface by the fluid through inclusion of the one or more dual function inhibitor compounds in the fluid.

Statement 12. A method may comprise: introducing one or more dual function inhibitor compounds through an umbilical into a deepwater environment such that the one or more dual function inhibitor compounds are introduced into a fluid in the deepwater environment, wherein the one or more dual function inhibitor compounds have the following structural formula:

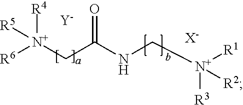

wherein each dual function inhibitor compound is a corrosion inhibitor and a hydrate inhibitor.

Statement 13. The method of statement 12, wherein each of R¹, R², and R³ independently comprises a C₁ to C₆ hydrocarbon chain; wherein R⁴ is selected from the group consisting of hydrogen and a C₁ to C₅₀ hydrocarbon chain and combinations thereof; wherein R⁵ and R⁶ are independently selected from the group consisting of hydrogen and a C₁ to C₅₀ hydrocarbon chain and combinations thereof; wherein X⁻ and Y⁻ are counter anions; and wherein a and b are independently an integer from 1 to 10.

Statement 14. The method of statement 12 or 13, wherein X⁻ and Y⁻ are selected from the group consisting of a carboxylate, a halide, a sulfate, am organic sulfonate, a phosphate, a phosphonate, a hydroxide, and any combination thereof.

Statement 15. The method of statements 12, 13, or 14, wherein R¹, R², and R³ is branched, unbranched, non-cyclic, cyclic, saturated, unsaturated, or combinations thereof.

Statement 16. The method of statements 12, 13, 14, or 15, wherein —R⁴R⁵R⁶N⁺— is a tertiary ammonium cation moiety.

Statement 17. The method of statements 12, 13, 14, 15, or 16, wherein —R⁴R⁵R⁶N⁺— is a quaternary ammonium cation moiety.

Statement 18. The method of statements 12, 13, 14, 15, 16, or 17 further comprising contacting a metal surface with the fluid after introduction of the one or more dual function inhibitor compounds; and suppressing corrosion of the metal surface by the fluid through inclusion of the one or more dual function inhibitor compounds in the fluid.

Statement 19. The method of statements 13, 14, 15, 16, 17, or 18, wherein the C₁ to C₆ hydrocarbon chain includes one or more hydrocarbon groups selected from the group consisting of alkyl, alkenyl, alkynyl, aryl, arylalkyl, arylalkenyl, alkylaryl, alkenylaryl, and combinations thereof.

Statement 20. A method may comprise: introducing one or more dual function inhibitor compounds into a fluid comprising a hydrocarbon and water such that the one or more dual function inhibitor compounds inhibits hydrate formation in the fluid, wherein the one or more dual function inhibitor compounds have the following structural formula:

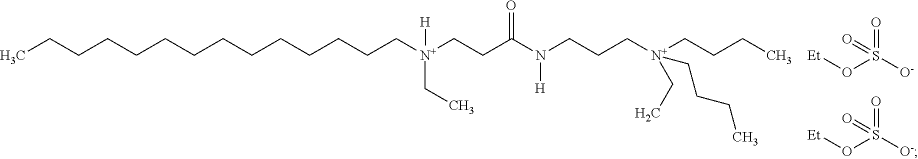

contacting a metal surface with the fluid after introduction of the one or more dual function inhibitor compounds; and suppressing corrosion of the metal surface by the fluid through inclusion of the one or more dual function inhibitor compounds in the fluid, wherein each dual function inhibitor compound is both a corrosion inhibitor and a hydrate inhibitor.

To facilitate a better understanding of the present disclosure, the following examples of certain aspects of some of the methods, compositions, and systems are given. In no way should the following examples be read to limit, or define, the entire scope of the disclosure.

### Example 1

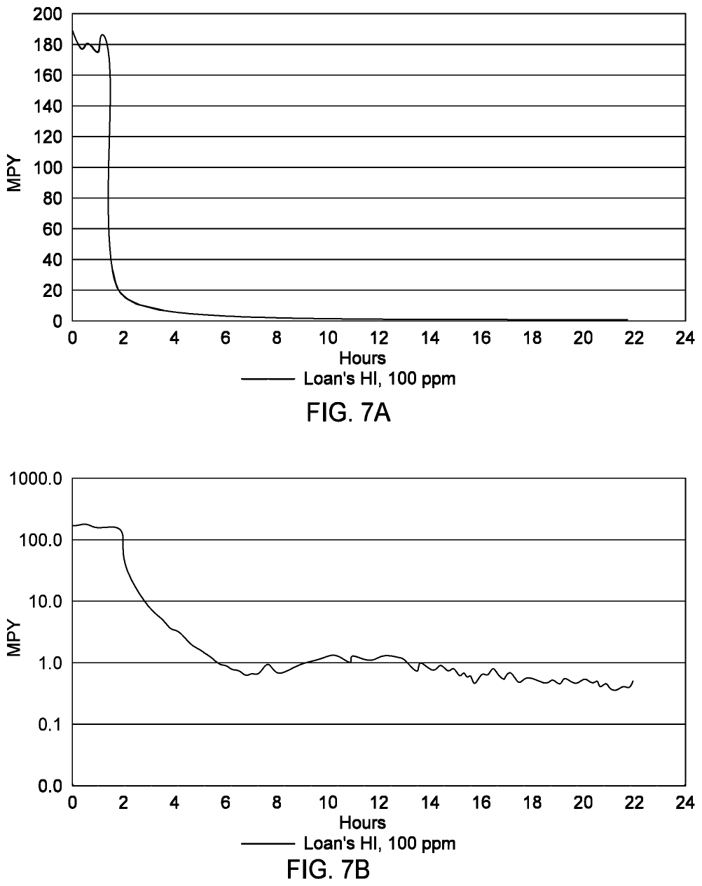

FIGS. 7A and 7B are graphical illustrations of Kettle test results depicting the corrosion inhibition performance of dual function inhibitor compounds in accordance with some embodiments. The graphical illustration shows a substantial reduction of a base corrosion rate of about 180 mpy (mils per year) to about 1 mpy at a dosage of 100 ppm which is significantly lower than what is generally used for hydrate inhibition. Hence, the graphical illustration shows the dual function inhibitor compounds disclosed herein may be effectively used in subsea application methods for both corrosion inhibition and hydrate inhibition. From an operations perspective, this dual function may be realized without any additional operating or capital expense.

The process conditions for the experiments included a pressure of from about 14.7 psi to about 20,000 psi and temperatures from about 0° C. to about 30° C. Kettle tests were performed to determine the results of corrosion inhibition. The kettle tests were carried out with 820 ml synthetic field brine, 80 ml kerosene, at 150° F. (66° C.), and a continuous CO₂ purge at a rate of 175 ml/min, using a magnetic stir bar or plate. The dual function inhibitor compound dosage was 60 ppm or 60% active. More specifically, 100 ppm of a 60% active dual function inhibitor compound was added to the test, resulting in 60 ppm active, wherein the balance was solvent.

### Example 2

Rocking cell tests were carried out on several samples including different dual function inhibitor compounds having structures according to some embodiments of the present disclosure. Rocking cell tests involved the injection of oil, water, a dual function inhibitor compound, and gas into a cell at representative conditions. Gas was injected into the cell to achieve a desired working pressure during the experiment. Each cell was of a fixed volume and contained constant mass during the experiment; that is, oil, water, a dual function inhibitor compound, and gas were injected at the beginning of the experiment, but thereafter the cell was closed to mass transfer in or out of the cell. Each cell also included a magnetic ball in the space where fluids are injected. The ball aided in agitation of the fluids during rocking. In addition, magnetic sensors on both ends of the cell detected whether the magnetic ball's movements through the fluids were hindered during rocking, wherein such hindrance could indicate the presence of hydrates. The cell also permitted visual observation of its contents during the experiment.

Initially, amounts of Mission Condensate oil, 6% NaCl, and a dual function inhibitor compound were injected into the cell so as to achieve a water cut of 55% (i.e., fraction of aqueous phase by volume in the total fluid) and a dual function inhibitor compound dosage of 0.25 to 5% by volume of the water phase (i.e., volume % of dual function inhibitor compound on water cut basis). After injection of oil, brine, and dual function inhibitor compound, gas was injected to reach a desired pressure (e.g., working pressure of a conduit of interest for evaluation of the dual function inhibitor compound, in this case around 2,800 psi).

Following injection of ale gas, the cell was closed and rocked for approximately 2 hours to emulsify the fluids therein. The temperature was then ramped down from about 20° C. to about 4° C. over a period of about 1 hour, and rocking was continued for around 16 hours after the temperature reached about 4° C. The rocking was then stopped for a period of time while the cell was horizontal (e.g., to simulate a system shut-in), This “shut-in” period lasted for at least 6 hours, varying only so that the re-start of rocking could be visually observed.

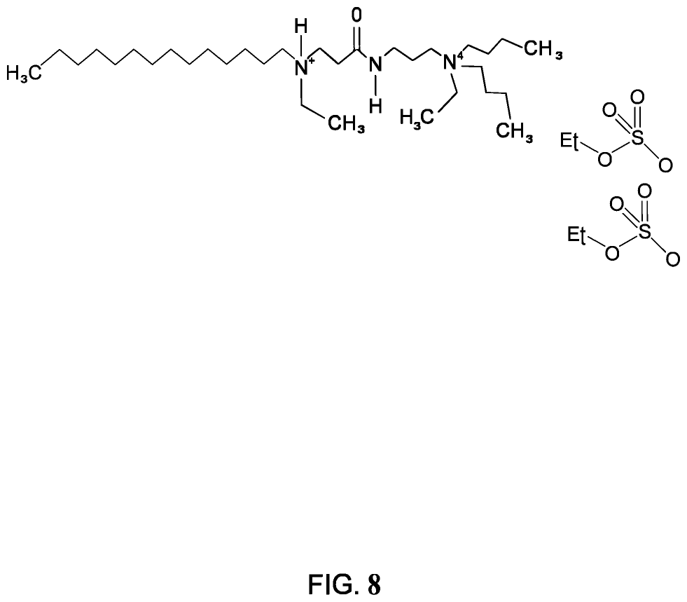

FIG. 8 is a depiction of a rocking cell test sample molecule of a dual function inhibitor compound in accordance with some embodiments. Visual inspection of the contents of the cell was made throughout the tests for visual rating of the performance of the dual function inhibitor compound. Samples were prepared of compositions including dual function inhibitor compounds with structures according to some embodiments of the present disclosure. The samples prepared included dual function inhibitor compounds having the structure shown in FIG. 8.

The samples having the structure shown in FIG. 8 passed the rocking cell test in the fluid with a water cut of 55%. These results of the rocking cell tests indicated that the compositions and methods of the present disclosure may facilitate, among other benefits, the inhibition, retardation, reduction, control, and/or delay of agglomeration of hydrates and/or hydrate-forming compounds in fluids having a water cuts as high as 55%.

It should be understood that, although individual examples may be discussed herein, the present disclosure covers all combinations of the disclosed examples, including, without limitation, the different component combinations, method step combinations, and properties of the system. The rocking cell testing results indicate the bis-quat molecule shows comparable performance as mono-cationic surfactants. The evidence for the chemical structure of FIG. 8 was determined by the total amine number being approximately zero, thereby indicating all amine functional groups had been quaternized.

It should be understood that the compositions and methods are described in terms of “comprising,” “containing,” or “including” various components or steps, the compositions and methods may also “consist essentially of” or “consist of” the various components and steps. Moreover, the indefinite articles “a” or “an,” as used in the claims, are defined herein to mean one or more than one of the elements that it introduces.

All numerical values within the detailed description and the claims herein modified by “about” or “approximately” with respect to the indicated value are intended to consider experimental error and variations that would be expected by a person having ordinary skill in the art.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

What is claimed is:

1. A method comprising:
introducing one or more dual function inhibitor compounds through an umbilical into a deepwater environment such that the one or more dual function inhibitor compounds are introduced into a fluid in the deepwater environment, wherein the one or more dual function inhibitor compounds have the following structural formula: 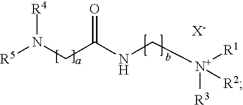
wherein each dual function inhibitor compound is both a corrosion inhibitor and a hydrate inhibitor.

2. The method of claim 1, wherein each of R¹, R², and R³ is each independently a C₁ to C₆ hydrocarbon chain, wherein the C₁ to C₆ hydrocarbon chain comprises one or more hydrocarbon groups selected from the group consisting of alkyl, alkenyl, alkynyl, aryl, arylalkyl, arylalkenyl, alkylaryl, alkenylaryl, and combinations thereof; wherein R⁴ and R⁵ are each independently selected from the group consisting of a hydrocarbon and a C₁ to C₅₀ hydrocarbon chain; and wherein X⁻ is a counter anion, and wherein each of a and b is independently an integer from 1 to 10.

3. The method of claim 1, wherein any one or more of R², and R³ is branched, unbranched, non-cyclic, cyclic, saturated, unsaturated, or combinations thereof.

4. The method of claim 1, wherein R⁴ and R⁵ are branched, unbranched, non-cyclic, cyclic, saturated, unsaturated, or combinations thereof.

5. The method of claim 1, wherein R⁴ and R⁵ are selected from the group consisting of alkyl, alkenyl, aryl, and combinations thereof.

6. The method of claim 1, wherein the one or more dual function inhibitor compounds comprise a linking moiety.

7. The method of claim 6, wherein the linking moiety comprises one or more hydrocarbon chains, wherein the hydrocarbon chains comprise C₁ to Cao chains or longer.

8. The method of claim 7, wherein the linking moiety is selected from the group consisting of methyl, ethyl, propyl, butyl, pentyl, hexyl, heptyl, octyl, nonyl, decyl, and combinations thereof.

9. The method of claim 1, wherein the one or more dual function inhibitor compounds comprise a hydrophobic portion and a hydrophilic portion.

10. The method of claim 1 further comprising contacting a metal surface with the fluid after introduction of the one or more dual function inhibitor compounds.

11. The method of claim 10 further comprising suppressing corrosion of the metal surface by the fluid through inclusion of the one or more dual function inhibitor compounds in the fluid.

12.-19. (canceled)

20. A method comprising:
introducing one or more dual function inhibitor compounds into a fluid comprising a hydrocarbon and water such that the one or more dual function inhibitor compounds inhibits hydrate formation in the fluid, wherein the one or more dual function inhibitor compounds have the following structural formula: 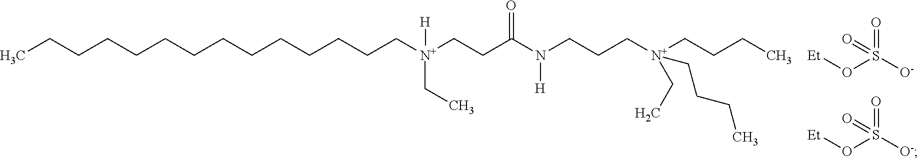
contacting a metal surface with the fluid after introduction of the one or more dual function inhibitor compounds; and
suppressing corrosion of the metal surface by the fluid through inclusion of the one or more dual function inhibitor compounds in the fluid,
wherein each dual function inhibitor compound is both a corrosion inhibitor and a hydrate inhibitor.

21. The method of claim 1, wherein the dual function inhibitor compounds are introduced into the fluid in an amount from about 0.1% to about 10% by volume based on the volume of water in the fluid.

22. The method of claim 20, further comprising introducing the dual function inhibitor compound into a deepwater environment through an umbilical line.

23. The method of claim 20, further comprising introducing the dual function inhibitor compound into horizontal, vertical, deviated, or otherwise nonlinear wellbores in a subterranean formation.

24. The method of claim 20, wherein the one or more dual function inhibitor compounds comprise a hydrophobic portion and a hydrophilic portion.

25. The method of claim 20, wherein the compound further comprises a linking moiety selected from the group consisting of methyl, ethyl, propyl, butyl, pentyl, hexyl, heptyl, octyl, nonyl, decyl, and combinations thereof.

26. The method of claim 20, wherein the dual function inhibitor compound is introduced into a composition prior to being introduced into the fluid, wherein the composition may comprise a solvent for the dual function inhibitor compound.

27. The method of claim 26, wherein the solvent is selected from the group consisting of methanol, isopropyl alcohol, glycol, ethylene glycol, any organic solvent, toluene, xylene, monobutyl ether, hexane, cyclohexane, and any combinations thereof.

28. The method of claim 20, wherein the dual function inhibitor compounds are introduced into the fluid in an amount from about 0.1% to about 10% by volume based on the volume of water in the fluid.
